(19) United States
(12) Patent Application Publication
(10) Pub. No.: US 2025/0376400 A1
(43) Pub. Date: Dec. 11, 2025

(54) INTEGRATION OF WATER TREATMENT AND WET AIR REGENERATION METHODS FOR THE DESTRUCTION OF PER- AND POLYFLUORINATED ALKYL SUBSTANCES (PFAS)

(71) Applicant: Lummus Technology LLC, Houston, TX (US)

(72) Inventors: Chad L. Felch, Kronenwetter, WI (US); Mark Allan Clark, Wausau, WI (US); Erika Lizette De Leon Gallegos, Houston, TX (US)

(21) Appl. No.: 19/220,839

(22) Filed: May 28, 2025

Related U.S. Application Data
(60) Provisional application No. 63/657,246, filed on Jun. 7, 2024.

(51) Int. Cl. C02F 9/00; C02F 1/28; C02F 1/44; C02F 1/467; C02F 101/36

(52) U.S. Cl. CPC C02F 9/00; C02F 1/283; C02F 1/444; C02F 1/4672; C02F 2101/36; C02F 2303/16

(57) ABSTRACT

Water treatment methods and systems for the collection and destruction of per- and polyfluorinated alkyl substances (PFAS) in water are provided. The systems and methods utilize a powdered activated carbon treatment (PACT) step and a wet air regeneration (WAR) treatment step followed by an electro-oxidation treatment step. The disclosed methods and systems are capable of destroying PFAS present in water streams and/or adsorption media, including groundwater, drinking water, or industrial or municipal wastewater.

### CROSS-REFERENCE TO RELATED APPLICATIONS

This application claims priority to and any benefit of U.S. Provisional Application No. 63/657,246, filed Jun. 7, 2024, the content of which is incorporated herein by reference in its entirety.

### FIELD

The present disclosure relates to methods of and systems for the destruction of per- and polyfluorinated alkyl substances (PFAS). More particularly, the present disclosure relates to a water treatment method including powder activated carbon technology (PACT) and a wet air regeneration (WAR) treatment step upstream from an electro-oxidation treatment step. The disclosed methods and systems are capable of destroying PFAS present in water streams, sludge slurries and/or adsorption media, including groundwater, drinking water, or industrial or municipal wastewater.

### BACKGROUND

Water sources including groundwater, drinking water, or wastewater often include undesirable contaminants. One class of contaminants that presents a growing concern is PFAS, colloquially known as “forever chemicals.” Specifically, it has become a public health priority in the United States and abroad to mitigate the effects of PFAS on the human population by preventing such contaminants from being ingested.

PFAS may be removed from a water stream using conventional adsorptive media technologies including, e.g., activated carbon or ion exchange. However, the adsorption media merely provides a means for removing—not destroying-PFAS from the water stream. The adsorption media contaminated with the collected PFAS must thereafter be disposed of.

Conventional methods of disposing contaminated adsorption media have been found to be insufficient. For example, there is inconclusive evidence as to whether incineration effectively destroys PFAS, as data collected from samples near incinerators burning PFAS adsorption media have shown elevated concentrations of PFAS remaining after otherwise presumed destruction. The more common conventional approach of disposing contaminated adsorption media in landfills has come under increasing scrutiny due to the dangers and pervasiveness of PFAS contamination in groundwater. For example, it has been noted that over time, the leachate from landfills begins to accumulate PFAS.

As such, a need exists for effective methods of destroying PFAS present in water streams or other sources of PFAS-contaminated adsorption media.

### SUMMARY

Disclosed herein are methods of and systems for the collection and destruction of PFAS. The methods and systems include a water treatment method including powder activated carbon technology (PACT) and a wet air regeneration (WAR) treatment step upstream from an electro-oxidation treatment step.

In accordance with a first aspect of the present disclosure, a water treatment system comprises a powdered activated carbon treatment (PACT) system comprising an amount of powdered activated carbon therein, a wet air regeneration (WAR) system in fluid communication with the PACT system and configured to regenerate the spent carbon material while destroying biological solids, a separation station in fluid communication with the WAR system to separate an effluent from the WAR system into a regenerated carbon solids fraction and a waste liquor containing the PFAS, a concentrator in fluid communication with the separation station to concentrate the PFAS in the waste liquor and provide a PFAS concentrate fraction and an effluent stream, and an electro-oxidation unit in fluid communication with the concentrator and configured to oxidize at least a portion of the PFAS in the PFAS concentrate fraction to provide an electro-oxidation effluent stream. The PACT system is configured to treat an amount of water comprising a concentration of per- and polyfluorinated alkyl substances (PFAS) to remove at least a portion of the PFAS from the water and produce a spent carbon material having the PFAS adsorbed thereon.

According to a second aspect, a water treatment system for treating water comprising a concentration of per- and polyfluorinated alkyl substances (PFAS) comprises an amount of powdered activated carbon configured to adsorb at least a portion of the PFAS, thereby forming a spent carbon material having the PFAS adsorbed thereon; a wet air regeneration (WAR) system configured to regenerate the spent carbon material; a separation station in fluid communication with the WAR system to separate an effluent from the WAR system into a regenerated carbon solids fraction and a waste liquor containing the PFAS; a concentrator in fluid communication with the separation station to concentrate the PFAS in the waste liquor and provide a PFAS concentrate fraction and an effluent stream; and an electro-oxidation unit in fluid communication with the concentrator and configured to oxidize at least a portion of the PFAS in the PFAS concentrate fraction to provide an electro-oxidation effluent stream.

According to a third aspect, a water treatment system comprises the water treatment system of the first or second aspects, wherein the WAR system comprises an outlet fluidly connected to the PACT system to provide the regenerated carbon solids fraction to the PACT system to treat additional water.

In a fourth aspect, a water treatment system comprises the water treatment system of any preceding aspect, further comprising a separator fluidly connected downstream of the PACT system and fluidly connected upstream of the WAR system, wherein the separator provides a clean water stream and a PFAS-containing slurry, and wherein the PFAS-containing slurry is directed to the WAR system and the clean water stream is output from the water treatment system. In a fifth aspect, the separator comprises an ultrafiltration (UF) membrane.

In a sixth aspect, a water treatment system comprises the water treatment system of any of the preceding aspects, wherein the electro-oxidation unit comprises an outlet fluidly connected to the PACT system to provide the electro-oxidation effluent stream to the PACT system for additional treatment by the PACT system.

In a seventh aspect, a water treatment system comprises the water treatment system of any of the preceding aspects, wherein the concentrator comprises a foam fractionation unit.

In an eighth aspect, a water treatment system comprises the water treatment system of any of the preceding aspects, further comprising a nutrient recovery unit configured to recover a nutrient fraction from the PFAS concentrate fraction. Such recovery methods may include chemical precipitation, biological and membrane techniques. In a ninth aspect, the nutrient recovery unit is fluidly coupled downstream of the electro oxidation system and upstream of the recycle back to carbon contact.

According to a tenth aspect, a method for removing per- and polyfluorinated alkyl substances (PFAS) from water is provided. The method comprises treating an amount of water containing PFAS in a powdered activated carbon (PACT) system. The treating removes PFAS from the water and produces a spent carbon material having the PFAS adsorbed thereon. The method also includes directing an amount of the spent carbon material having the PFAS adsorbed thereon to a wet air regeneration (WAR) system for regeneration of the spent carbon material and destruction of biological solids, separating an effluent from the WAR system into a regenerated carbon solids fraction and a waste liquor containing the PFAS, directing the waste liquor to a concentrator to concentrate the PFAS, wherein the concentrator produces a PFAS concentrate fraction and an effluent stream, providing the PFAS concentrate to an electro-oxidation unit configured to oxidize at least a portion of the PFAS in the PFAS concentrate fraction to provide an electro-oxidation effluent stream and directing the electro-oxidation effluent stream to the PACT system.

In an eleventh aspect, a method comprises the method of the tenth aspect, further comprising directing the regenerated carbon solids fraction to the PACT system.

In a twelfth aspect, a method comprises the method of the tenth or eleventh aspects, further comprising directing the effluent (further clarified as the stream low in PFAS exiting the concentrator) stream from the concentrator to the PACT system.

In a thirteenth aspect, a method comprises the method of any one of the tenth through twelfth aspects, further comprising separating the spent carbon material having the PFAS adsorbed thereon into a water stream essentially free from suspended solids and PFAS (clean water) and a PFAS-containing slurry. The PFAS-containing slurry is directed to the WAR system and the clean water stream is provided as an output. In a fourteenth aspect, the separating comprises using an ultrafiltration (UF) membrane. In a fifteenth aspect, the clean water stream is free of PFAS.

In a sixteenth aspect, a method comprises the method of any one of the tenth through fifteenth aspects, further comprising recovering a nutrient fraction from the PFAS concentrate fraction. In a seventeenth aspect, the nutrient fraction is provided prior to recycling the electro oxidation effluent to the carbon contact step.

In an eighteenth aspect, a method comprises the method of any one of the tenth through seventeenth aspects, wherein the electro-oxidation effluent stream is combined with an amount of water.

In a nineteenth aspect, a method comprises the method of any one of the tenth through eighteenth aspects, further comprising separating an amount of ash from the regenerated carbon solids fraction or the waste liquor.

### DESCRIPTION OF THE FIGURE

The advantages of the inventive concepts will be apparent upon consideration of the following detailed disclosure, especially when taken in conjunction with the accompanying drawing wherein:

FIG. 1 illustrates a block flow diagram of an exemplary water treatment system in accordance with the present disclosure.

### DETAILED DESCRIPTION

Disclosed herein are methods of and systems for the collection and destruction of per- and polyfluorinated alkyl substances (PFAS) in water treatment processes. While the present disclosure describes certain embodiments of the methods and systems in detail, the present disclosure is to be considered exemplary and is not intended to be limited to the disclosed embodiments.

As used herein, the term “unit” generally refers to a unit operation. A unit operation may be one or more basic operations in a process. A unit may have one or more sub-units (or subsystems). Unit operations may involve a physical change or chemical transformation, such as separation, crystallization, evaporation, filtration, polymerization, isomerization, other reactions, or combinations thereof. A unit may include one or more individual components.

As used herein, the terms “water” and “water stream” encompass any water to be treated such as surface water, ground water, and a stream of wastewater from industrial, agricultural, and municipal sources, having pollutants that may include biodegradable material, inorganic, labile organic compounds capable of being decomposed by bacteria, biologically refractory compounds, and/or biologically inhibitory compounds, flowing or otherwise introduced into a water treatment system. Although various aspects are described herein with reference to wastewater, it should be understood that the methods and systems of any of the aspects herein may be employed for treatment of surface water, drinking water, landfill leachate, and other water streams that contain an appreciable amount of background organics.

Reference will be made to the figure to further describe the methods and systems of the present disclosure. It should be appreciated that the features illustrated in the figure are not necessarily drawn to scale. In the figure, the direction of fluid flow is indicated by arrows. Fluid may be directed from one unit to another, for example, with the aid of valves and a fluid flow system. As those of skill in the art will appreciate, such fluid flow systems may include compressors and/or pumps, as well as a control system for regulating fluid flow.

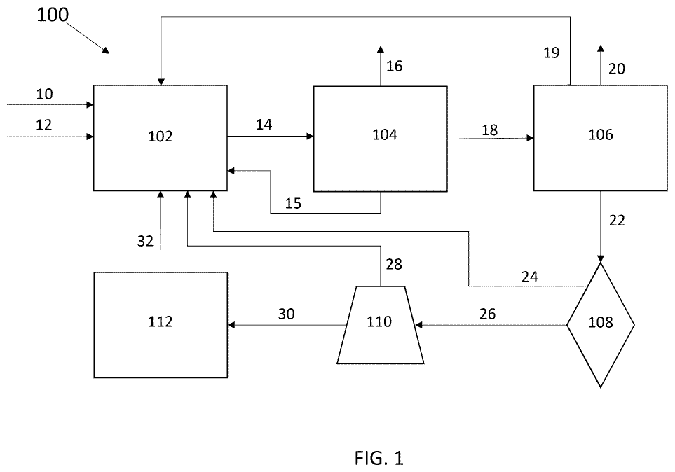

With reference to FIG. 1, a block flow diagram of a water treatment system 100 is shown. The water treatment system 100 comprises a powdered activated carbon treatment (PACT) system 102, a separator 104, a wet air regeneration (WAR) system 106, a separation station 108, a concentrator 110, and an electro-oxidation unit 112. Although depicted in FIG. 1 as being separate units, it should be understood that, in aspects, the functionality of one or more of the units of the water treatment system 100 can be incorporated into another one of the units.

In general, an inlet stream 10 entering the water treatment system 100 comprises contaminants including, inter alia, per- and polyfluorinated alkyl substances (PFAS), pesticides, herbicides, phenols, phthalates, hydrocarbons, and the like. Inlet stream 10 may comprise a water stream, including groundwater, drinking water, or industrial or municipal wastewater. The inlet stream 10 is delivered to the PACT system 102 from a water source in fluid communication with the PACT system 102. As used herein, by “fluid communication,” it is meant that a fluid may flow from one component to another component.

The PACT system 102 can include one or more aeration basins or vessels comprising an amount of powdered activated carbon 12. The aeration basin or vessels may be, for example, existing treatment vessels at brownfield facilities to which powdered activated carbon 12 is added. Accordingly, in aspects, pre-existing infrastructure may be employed, with or without modification, to remove PFAS from the water.

The powdered activated carbon is present in an amount effective to adsorb or otherwise remove a desired amount of one or more contaminants, such as organic contaminants, from the water. In aspects disclosed herein, the powdered activated carbon may be effective to remove at least a portion of the PFAS from the water. Other contaminants may additionally be reduced through treatment in the PACT system. In any of the aspects disclosed herein, other adsorbents may be employed in addition to, or as an alternative to, activated powdered carbon.

In aspects, the PACT system 102 further includes a biomass population suitable to promote the treatment of the water. The biomass population may include any suitable population of bacterial micro-organisms effective to digest biodegradable material. The bacteria may comprise any bacteria or combination of bacteria suitable to thrive in anoxic, anaerobic, and/or aerobic conditions. The powdered activated carbon in the PACT system 102 may act as a ballast for the biomass population, thereby allowing a larger population of bacteria in the PACT system 102 and, in turn, increasing the treatment level in the vessels. Moreover, the powdered activated carbon in the PACT system 102 may protect the biomass population from potentially toxic or inhibitory compounds by adsorbing the compounds and carrying them out of the PACT system 102 for processing and destruction. Accordingly, while the biomass population will eliminate biodegradable organics from the water, the non-biodegradable organics (including PFAS) are adsorbed onto the powdered activated carbon material.

It should be appreciated that the activated carbon material may be utilized to concentrate the one or more contaminants of the water until the carbon material becomes “spent.” In aspects, the activated carbon material becomes spent when the ability of the carbon material to remove further contaminants from the water has become nearly or completely exhausted and/or when the water comprises more than a predetermined amount of contaminants. The amount of contaminants may be made by suitable quantitative or semi-quantitative methods, such as those methods including the use of chromatography. The PACT system produces a spent carbon material 14 having PFAS adsorbed thereon. In aspects in which a biomass population is included in the PACT system, the spent carbon material 14 may further include an amount of biological sludge material.

In aspects, the spent carbon material 14 may be in the form of a slurry or sludge having a water content ranging from about 80% to about 97% (solids content of from about 3% to about 20%). As used herein, the term “about” refers to a value which may be ±5% of the stated value.

As shown in FIG. 1, the spent carbon material 14 may be directed to a separator 104 fluidly connected downstream of the PACT system 102 and upstream of the WAR system 106. The separator 104 receives the spent carbon material 14 and provides a clean water stream 16 and a PFAS-containing slurry 18. The separator 104 may be a membrane, for example, an ultrafiltration (UF), reverse osmosis, nanofiltration, microfiltration, or other solid/liquid separation method known and used in the art. The membrane may be of any configuration, including, but not limited to, a sheet or hollow tube. Moreover, the separator 104 may be configured as another type of solid/liquid separation device as an alternative to a membrane, such as a clarifier, a gas or air flotation unit, equipment for gravity settling, or the like, provided it is capable of separating the contaminants present in the spent carbon material 14 (e.g., the PFAS) from the clean water stream 16. In aspects, the separator 104 may be affixed to an outlet of the PACT system 102, or may be configured as a standalone component. In aspects, the spent carbon material 14 may be conditioned in a gravity thickener (e.g., a sedimentation tank) to provide the PFAS-containing slurry 18 for input into the WAR system 106.

As shown in FIG. 1, the system may include a recirculation line 15 to recirculate spent carbon material 14 and biomass from the separator 104 to the PACT system 102. The clean water stream 16 may be output from the water treatment system 100, as shown in FIG. 1, while the PFAS-containing slurry 18 is directed to the WAR system 106. It should be appreciated that, although referred to as the “PFAS-containing slurry,” the slurry directed to the WAR system may also include active carbon having PFAS adsorbed thereon and spent carbon and sludge.

In aspects, the WAR system 106 may comprise one or more dedicated reactor vessels (WAR units) and provides regeneration of the spent carbon material and aqueous phase oxidation of undesirable constituents by an oxidizing agent at an elevated temperature and pressure. Although the WAR system may not have a significant impact on the destruction of PFAS, the WAR system may destroy greater than 90% of the biological sludge while regenerating the activated carbon by desorbing organics and breaking large molecules into short chain organics which have improved biodegradability and less of an affinity to absorb onto carbon as compared to the large molecule organics. Accordingly, the short chain organics can be returned to the PACT system 102 for elimination. The oxidizing agent may comprise molecular oxygen from an oxygen-containing gas, including, for example, a pressurized oxygen-containing gas supplied by a compressor. The oxidant may be added to the PFAS-containing slurry 18 through a heat exchanger (not shown in FIG. 1).

The PFAS-containing slurry 18 is thus treated in the WAR system 106 in a hydrothermal process to solubilize and reduce the chemical oxygen demand (COD) associated with biological sludge and the adsorption media (e.g., activated carbon or ion exchange media) in the PFAS-containing slurry 18. As used herein, the term “COD” or “Chemical Oxygen Demand,” refers to a measure of the amount of oxygen required to fully oxidize organic and inorganic contaminants in water. COD measurement includes biologically labile, biologically inhibitory, and biologically refractory compounds. Unless otherwise specified, it should be understood that COD does not refer to the presence or measure of PFAS contaminants, as those specific compounds are described separately herein.

As set forth above, the WAR system 106 also serves to move PFAS and other contaminants adsorbed on the carbon material from the solid phase adsorbent media to a liquid (i.e., water-based) phase for downstream electro-oxidation processing. Some the organic components may be fully oxidized to carbon dioxide while other constituents may be oxidized into biodegradable short chain organic acids, such as acetic acid. Inorganic constituents including sulfides, mercaptides, and cyanides may also be oxidized.

One particular operational benefit of the disclosed WAR system 106 is the recovery of heat released from the exothermic reactions that occur when the adsorption media is oxidized, which can reduce operating expenses. In some aspects, the oxidation process in the WAR system 106 is carried out at a temperature of from 150° C. to 300° C., including from 175° C. to 300° C., including from 200° C. to 280° C., including from 200° C. to 260° C., including less than 260° C. In some aspects, the oxidation process in the WAR system 106 is carried out at a pressure of from 300 psig to 3,000 psig, including from 300 psig to 2,000 psig, including from 500 psig to 1,000 psig, including less than 1,000 psig, including from 600 psig to 900 psig, including at about 800 psig.

Offgas 19 and inorganic ash 20 are output from the destruction of the biological solids by the WAR system 106. The inorganic ash 20 can be removed from the WAR system 106 through a suitable ash removal process. One suitable process which can be used to remove ash from regenerated carbon is referred to as a Differential Sedimentation and Elutriation (DSE) process. An example DSE process and components for carrying out the same are described in U.S. Pat. No. 4,749,492, the entirety of which is incorporated by reference herein. The offgas 19 can be returned to the PACT system 102 for further processing, as shown in FIG. 1, or to another safe location.

In the DSE process, regenerated adsorbent particles (e.g., carbon material) may be recovered from a wet oxidation-regenerated mixed liquor sludge by diluting and settling a blowdown slurry from the wet oxidation reactor to obtain a first aqueous phase containing primarily regenerated adsorbent particles and fine ash particles, and a first solids phase containing primarily grit particles. The first aqueous phase is combined with a portion of the regenerated adsorbent particle slurry after treatment with a dispersing agent and then an anionic flocculating agent. The mixture is then settled to obtain a second aqueous phase containing primarily fine ash particles and a second solids phase containing primarily regenerated adsorbent particles. The ash 20 is disposed from the water treatment system 100.

Additionally, the WAR system 106 produces an effluent 22 which includes at least regenerated carbon material and a waste material, e.g., alcohols, hydrocarbons, PFAS, and/or nitrogen compounds, and the like. The WAR system 106 comprises an outlet fluidly connected to the PACT system 102 to provide the regenerated carbon material to the PACT system 102 to treat additional water. In aspects, the outlet of the WAR system 106 is fluidly connected to the PACT system 102 through at least a separation station 108. Accordingly, in such aspects, the effluent 22 is delivered to a separation station 108 in fluid communication with the WAR system 106.

The separation station 108 separates the effluent 22 from the WAR system 106 into a regenerated carbon solids fraction 24 comprising regenerated carbon material and a waste liquor 26 containing the PFAS and other byproducts from the WAR process. As used herein, the term “cleaned” refers to a liquid portion comprising byproducts from the effluent 22 that are removed from the effluent 22 such that a remaining carbon solids portion includes a reduced amount of the PFAS and byproducts from the WAR process. As such, the separation station 108 comprises suitable components necessary for carrying out a separation technique or other process which may provide the regenerated carbon solids fraction 24 and the waste liquor 26 comprising PFAS, soluble biological oxygen demand (BOD), and byproducts from regeneration. In aspects, the separation station 108 is configured to carry out one or more separation and/or filtration processes.

In aspects, the separation station 108 may comprise a centrifuge, a recessed plate filter press, a vacuum filtration apparatus, a solid/liquid hydrocyclone, one or more gravity thickeners (e.g., arranged in series), one or more elutriators, and/or components suitable to carry out repeated decanting/reconstitution techniques to generate the relevant liquid and solid fractions. In any of the aspects described herein, the regenerated carbon solids fraction 24 and the waste liquor 26 may be produced by decanting and removing a liquid portion from the effluent 22, rediluting the remaining material back to original volume with contaminant-free water, decanting again, and removing an additional liquid portion.

The separation station 108 may further include components suitable for washing the regenerated carbon solids fraction 24. For example, the separation station 108 may include a filter press, a vacuum filter, a centrifuge, or the like, along with components supplying water, such as clean water jets or a wash drum to flush fresh fluid through a filter cake of the regenerated carbon solids. In aspects, the regenerated carbon solids fraction 24 is directed from the separation station 108 to the PACT system 102. Because the regenerated carbon solids fraction 24 is substantially free of contaminants, the regenerated carbon solids fraction 24 reduces the need for additional activated carbon to be added to the system and recycles and reuses the regenerated carbon material from the WAR system 106. The regenerated carbon solids may produce a better quality effluent when returned to the PACT system than virgin powdered activated carbon, thereby increasing the adsorptive qualities of the activated carbon material.

In some aspects, the waste liquor 26 is directed from the WAR system 106 to a concentrator 110. The concentrator 110 may be any device suitable for decreasing the volume of water containing PFAS, for example, foam fractionation, regenerable ion exchange, reverse osmosis, or the like to concentrate the waste liquor and, specifically, to concentrate the PFAS in the waste liquor 26, prior to treatment in the electro-oxidation unit 112. It should be understood that the concentrator 110 can be substituted with any device suitable for facilitating the separation of some portion of PFAS from water in the waste liquor 26. The concentrator 110 thus increases the efficiency of the PFAS destruction in the downstream electro-oxidation unit 112 by concentrating PFAS into a concentration range that improves the kinetics in the reactions occurring in electro oxidation. In aspects, the concentrator 110 is a foam fractionation unit, although other concentrator technologies are contemplated and possible, including reverse osmosis, regenerable media, single use media, and the like.

It should be understood that it is within the purview of this disclosure to incorporate a concentration method prior to electro-oxidation even in aspects not including a freestanding concentrator. For example, the functionality of the concentrator 110 can be incorporated into the separation station 108, the WAR system 106, or the electro-oxidation unit 112 as an additional separations and concentration step. Regardless of whether the concentrator is incorporated into another unit or provided as a standalone unit, the concentrator 110 is effective to provide an effluent stream 28 and a PFAS concentrate fraction 30. The effluent stream 28 contains biodegradable COD, which is recycled to the PACT system 102 for further processing.

Although not depicted in FIG. 1, in aspects, nutrients such as nitrogen and phosphorus may be recovered by a nutrient recovery unit following the WAR process. For example, nutrients may be recovered from the waste liquor 26 output from the separation station 108, or from the effluent stream 28 of the concentrator 110. Accordingly, in aspects, the water treatment system 100 may include components suitable to carry out a process to treat and/or remove the nitrogen- and phosphorous-containing contaminants, such as a precipitation unit configured to recover a nutrient fraction from the waste liquor 26, the effluent stream 28, or the PFAS concentrate fraction 30. In some aspects, the nutrient fraction may be recovered from an electro-oxidation effluent stream 32. The nutrient recovery unit may use any one of a variety of suitable methods to separate the nutrients from the remaining materials, such as chemical precipitation, biological and membrane techniques, and the like. The nutrient recovery unit (e.g., precipitation unit) may be fluidly coupled downstream of the WAR system 106 and upstream of the concentrator 110, or downstream of the WAR system 106 and the concentrator 110. The nutrients (e.g., the nitrogen- and phosphorous-containing contaminants) may be removed from the system and utilized for other applications, such as fertilizer applications.

The PFAS concentrate fraction 30 exits the concentrator 110 and is fed to the electro-oxidation unit 112. The electro-oxidation unit 112 is configured to destroy PFAS contaminants in the PFAS concentrate fraction to a desired level. In general, the electro-oxidation unit 112 comprises subcomponents (not pictured) including, inter alia, a pump, a filter, a cooler, a power supply, and a reactor. The pump, if used, may include any type of pump operable to draw fluid from an intake or source and direct that fluid at a desired flow rate and pressure through the electro-oxidation process. The filter may be positioned to filter larger contaminants and debris from the fluid prior to the fluid passing through the cooler. The cooler operates to cool the fluid to a desired temperature before the fluid is directed to the reactor. The reactor uses electrically conductive, freestanding, substrate-less, synthetic diamond electrodes. For example, the electro-oxidation unit 112 may incorporate one or more boron doped diamond (BDD) electrodes. However, it is contemplated and possible that other known materials may be used for the electrodes. Electrical current is provided to the electrode by the power supply.

In general, electro-oxidation is a treatment process that flows water between electrodes, while simultaneously passing an electrical current through the electrodes. As the electrical current is conducted across between electrodes through the water, it creates free-radicals. For example, the electrical current splits apart some of the water molecules, forming hydroxyl radicals (OH−) and hydrogen ions (H+). The free radicals including the hydroxyl radicals are strong oxidizers that are able to oxidize and mineralize organic molecules they encounter, including fluorocarbons. In addition, electrons may be transferred directly on the electrode surface to perform oxidation. The PFAS is thus converted to carbon dioxide and fluoride ions, thereby removing the contamination from the inlet stream. Electro-oxidation has been shown to destroy PFAS of all different carbon lengths.

The degree of PFAS destruction and COD reduction in the electro-oxidation treatment step corresponds directly to the current density and the amount of time the electro-oxidation step is operated. In accordance with the present disclosure, the electro-oxidation process is carried out a current density of from 100 A/m² to 50,000 A/m², including from 1,000 A/m² to 30,000 A/m², from 1,000 A/m² to 10,000 A/m², from 1,000 A/m² to 7,500 A/m², from 2,000 A/m² to 50,000 A/m², from 2,000 A/m² to 30,000 A/m², from 2,000 A/m² to 10,000 A/m², or from 2,000 A/m² to 7,500 A/m², including at about 1,000 A/m², about 2,000 A/m², or about 5,000 A/m². The electro-oxidation step may be operated as a continuous process or as a batch process.

The features of the electro-oxidation process that takes place within the electro-oxidation unit 112 are further described in co-pending U.S. Pat. Appln. Pub. No. 2023/0024923, which is incorporated by reference herein in its entirety.

With continued reference to FIG. 1, an electro-oxidation effluent stream 32 exits the electro-oxidation unit 112. The electro-oxidation unit 112 comprises an outlet fluidly connected to the PACT system 102 to provide the electro-oxidation effluent stream 32 to the PACT system 102 for additional treatment by the PACT system 102. For example, at least a portion of the electro-oxidation effluent stream 32 may be redirected back to the PACT system 102. The electro-oxidation effluent stream 32 may be combined with the inlet stream 10 for further processing in the water treatment system 100. Alternatively, or additionally, the electro-oxidation effluent stream 32 may directly proceed to further processing in the PACT system 102.

Although various aspects of the disclosure may include an electro-oxidation unit 112, it is contemplated that in any of the aspects herein, alternative PFAS destruction methods may be incorporated into the water treatment system 100. For example, UV reduction, ball milling, sonolysis, plasma, pyrolysis, gasification, super critical oxidation, or the like may be utilized in place of electro-oxidation treatment of the PFAS concentrate fraction. Accordingly, the electro-oxidation unit 112 may be replaced with devices suitable for carrying out any one of these processes.

As set forth previously, conventional modes of removing PFAS using adsorptive media technologies including, e.g., activated carbon or ion exchange, have shown to be effective in the sense of a reduction of the presence of such contaminants in a water stream. However, the adsorption media merely provides a means for removing—not destroying-PFAS from the water stream. The adsorption media contaminated with the collected PFAS must thereafter be disposed of, and prior to the instant disclosure, an effective means of selectively removing the PFAS from the adsorption media had not been found.

Electro-oxidation is a known process to destroy PFAS contaminants in water, i.e., the use of a current to destroy PFAS. However, electro-oxidation is a power intensive process, and does not provide selective destruction of contaminants. Accordingly, PFAS are destroyed along with all other contaminants in the inlet stream. While electro-oxidation is able to destroy an inlet slurry comprising a saturated adsorption media (i.e., solids) and PFAS-contaminated water on a lab scale, the high operating costs (e.g., in electricity usage) of single-step electro-oxidation so as to directly destroy both the adsorption media solids and the PFAS contaminants on an industrial scale may not be economically unfeasible.

Separately, wet air regeneration (WAR) has generally been invoked as a solution to PFAS contaminants in water. However, conventional knowledge in the art is that subcritical (i.e., low temperature) WAR processing is not sufficiently effective at destroying PFAS.

Here, though, the inventors have surprisingly found that the combination of wet air regeneration upstream from electro-oxidation provides a near total destruction of PFAS while enabling recycling of the adsorption media, and further, provides substantial processing efficiencies from an economical perspective. In other words, the use of WAR to desorb the PFAS from the adsorption media enables the PFAS to be routed to the electro-oxidation for destruction while the adsorption media is regenerated and provided to the PACT system for reuse.

Moreover, as set forth previously, electro-oxidation as a stand-alone step has high capital and operating costs when destroying PFAS adsorption media solids. Specifically, in order to sufficiently destroy PFAS compounds, high current density electro-oxidation is required. However, utilizing the requisite high current density needed for PFAS against an entire inlet adsorption media (i.e., direct electro-oxidation of all oxidizable materials in a water adsorptive media matrix) is highly inefficient and results in exorbitant energy costs. Here, by conducting an upstream WAR step, the adsorbent media is removed from inlet stream to the high current density electro-oxidation unit. As such, the high current density electro-oxidation step is specifically targeted to PFAS destruction, without wasting costly resources (e.g., electricity) on destruction of the adsorption media.

In sum, the inventors have found that the combination of PACT, WAR, and electro-oxidation provides a flexible, cost-effective solution for destroying PFAS-containing adsorption media. Moreover, by using the PACT process, the non-PFAS organics do not need to be treated in through electro-oxidation. Instead, the non-PFAS organics are treated by bacteria, which can enable the media to be recycled but also reduces the spend rate of the media.

The terminology as set forth herein is for description of the embodiments only and should not be construed as limiting the disclosure as a whole. All references to singular characteristics or limitations of the present disclosure shall include the corresponding plural characteristic or limitation, and vice versa, unless otherwise specified or clearly implied to the contrary by the context in which the reference is made. Unless otherwise specified, “a,” “an,” “the,” and “at least one” are used interchangeably. Furthermore, as used in the description and the appended claims, the singular forms “a,” “an,” and “the” are inclusive of their plural forms, unless the context clearly indicates otherwise.

To the extent that the term “includes” or “including” is used in the description or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use.

All combinations of method or process steps as used herein can be performed in any order, unless otherwise specified or clearly implied to the contrary by the context in which the referenced combination is made.

All ranges and parameters, including but not limited to percentages, parts, and ratios, disclosed herein are understood to encompass any and all sub-ranges assumed and subsumed therein, and every number between the endpoints. For example, a stated range of “1 to 10” should be considered to include any and all sub-ranges beginning with a minimum value of 1 or more and ending with a maximum value of 10 or less (e.g., 1 to 6.1, or 2.3 to 9.4), and to each integer (1, 2, 3, 4, 5, 6, 7, 8, 9, and 10) contained within the range.

The methods and systems of the present disclosure can comprise, consist of, or consist essentially of the essential elements of the disclosure as described herein, as well as any additional or optional element described herein, or which is otherwise useful in water treatment applications.

In accordance with the present disclosure, it is possible to utilize the various inventive concepts in combination with one another. Additionally, any particular feature recited as relating to a particularly disclosed aspect of the methods and systems of the present disclosure should be interpreted as available for use with all disclosed aspects of the methods and systems of the present disclosure, unless incorporation of the particular feature would be contradictory to the express terms of the disclosed aspect. Additional advantages and modifications will be readily apparent to those skilled in the art. Therefore, the disclosure, in its broader aspects, is not limited to the specific details presented therein, the representative apparatus, or the illustrative examples shown and described. Accordingly, departures may be made from such details without departing from the spirit or scope of the general inventive concepts.

What is claimed is:

1. A water treatment system comprising:
a powdered activated carbon treatment (PACT) system comprising an amount of powdered activated carbon therein, wherein the PACT system is configured to treat an amount of water comprising a concentration of per- and polyfluorinated alkyl substances (PFAS) to remove at least a portion of the PFAS from the amount of water and produce a spent carbon material having the PFAS adsorbed thereon;
a wet air regeneration (WAR) system in fluid communication with the PACT system and configured to regenerate the spent carbon material while destroying biological solids;
a separation station in fluid communication with the WAR system to separate an effluent from the WAR system into a regenerated carbon solids fraction and a waste liquor containing the PFAS;
a concentrator in fluid communication with the separation station to concentrate the PFAS in the waste liquor and provide a PFAS concentrate fraction and an effluent stream; and
an electro-oxidation unit in fluid communication with the concentrator and configured to oxidize at least a portion of the PFAS in the PFAS concentrate fraction to provide an electro-oxidation effluent stream.

2. The water treatment system of claim 1, wherein the WAR system comprises an outlet fluidly connected to the PACT system to provide the regenerated carbon solids fraction to the PACT system to treat additional water.

3. The water treatment system of claim 1, further comprising a separator fluidly connected downstream of the PACT system and fluidly connected upstream of the WAR system, wherein the separator provides a clean water stream and a PFAS-containing slurry, and wherein the PFAS-containing slurry is directed to the WAR system and the clean water stream is output from the water treatment system.

4. The water treatment system of claim 3, wherein the separator comprises an ultrafiltration (UF) membrane.

5. The water treatment system of claim 1, wherein the electro-oxidation unit comprises an outlet fluidly connected to the PACT system to provide the electro-oxidation effluent stream to the PACT system for additional treatment by the PACT system.

6. The water treatment system of claim 1, wherein the concentrator comprises a foam fractionation unit.

7. The water treatment system of claim 1, further comprising a precipitation unit configured to recover a nutrient fraction from the PFAS concentrate fraction.

8. The water treatment system of claim 7, wherein the precipitation unit is fluidly coupled downstream of the WAR system and upstream of the PACT system.

9. A method for removing per- and polyfluorinated alkyl substances (PFAS) from water, the method comprising:
treating an amount of water containing PFAS in a powdered activated carbon (PACT) system, wherein the treating removes PFAS from the water and produces a spent carbon material having the PFAS adsorbed thereon;
directing an amount of the spent carbon material having the PFAS adsorbed thereon to a wet air regeneration (WAR) system for regeneration of the spent carbon material and destruction of biological solids;
separating an effluent from the WAR system into a regenerated carbon solids fraction and a waste liquor containing the PFAS;
directing the waste liquor to a concentrator to concentrate the PFAS, wherein the concentrator produces a PFAS concentrate fraction and an effluent stream;
providing the PFAS concentrate fraction to an electro-oxidation unit configured to oxidize at least a portion of the PFAS in the PFAS concentrate fraction to provide an electro-oxidation effluent stream; and
directing the electro-oxidation effluent stream to the PACT system.

10. The method of claim 9, further comprising directing the regenerated carbon solids fraction to the PACT system.

11. The method of claim 9, further comprising directing the effluent stream from the concentrator to the PACT system.

12. The method of claim 9, further comprising separating the spent carbon material having the PFAS adsorbed thereon into a clean water stream and a PFAS-containing slurry, and wherein the PFAS-containing slurry is directed to the WAR system and the clean water stream is provided as an output.

13. The method of claim 12, wherein the separating comprising using an ultrafiltration (UF) membrane.

14. The method of claim 12, wherein the clean water stream is free of PFAS.

15. The method of claim 9, further comprising recovering a nutrient fraction from the PFAS concentrate fraction.

16. The method of claim 15, wherein the nutrient fraction is provided prior to concentrating the PFAS from the waste liquor.

17. The method of claim 9, wherein the electro-oxidation effluent stream is combined with an additional amount of water.

18. The method of claim 9, further comprising separating an amount of ash from the regenerated carbon solids fraction or the waste liquor.

19. A water treatment system for treating water comprising a concentration of per- and polyfluorinated alkyl substances (PFAS) comprising:
an amount of powdered activated carbon configured to adsorb at least a portion of the PFAS, thereby forming a spent carbon material having the PFAS adsorbed thereon;
a wet air regeneration (WAR) system configured to regenerate the spent carbon material;
a separation station in fluid communication with the WAR system to separate an effluent from the WAR system into a regenerated carbon solids fraction and a waste liquor containing the PFAS;
a concentrator in fluid communication with the separation station to concentrate the PFAS in the waste liquor and provide a PFAS concentrate fraction and an effluent stream; and
an electro-oxidation unit in fluid communication with the concentrator and configured to oxidize at least a portion of the PFAS in the PFAS concentrate fraction to provide an electro-oxidation effluent stream.
